(19) United States
(12) Patent Application Publication
(10) Pub. No.: US 2021/0224610 A1
(43) Pub. Date: Jul. 22, 2021

(54) Systems and Methods for Disentangling Factors of Variation in Computer Vision Systems Using Cycle-Consistent Variational Auto-Encoders

(71) Applicant: Insurance Services Office, Inc., Jersey City, NJ (US)

(72) Inventors: Ananya Harsh Jha, Brooklyn, NY (US); Saket Anand, New Delhi (IN); Maneesh Kumar Singh, Lawrencville, NJ (US); Venkata Subbarao Veeravarasapu, Munich (DE)

(73) Assignee: Insurance Services Office, Inc., Jersey City, NJ (US)

(21) Appl. No.: 17/152,424

(22) Filed: Jan. 19, 2021

Related U.S. Application Data
(60) Provisional application No. 62/962,455, filed on Jan. 17, 2020.
(60) Provisional application No. 62/991,862, filed on Mar. 19, 2020.

(51) Int. Cl. G06K 9/62

(52) U.S. Cl. CPC G06K 9/6267; G06K 9/6259

(57) ABSTRACT

Computer vision systems and methods for image to image translation are provided. The system samples a first image and a second image of a dataset. The system utilizes a variational auto-encoder to execute a cycle consistent forward cycle and a cycle consistent reverse cycle on each of the first image and the second image to generate a disentanglement representation of the first image and a disentanglement representation of the second image, and generate a first reconstructed image and a second reconstructed image based on the first image disentanglement representation and the second image disentanglement representation.

### RELATED APPLICATIONS

This application claims priority to U.S. Provisional Patent Application Ser. No. 62/962,455 filed on Jan. 17, 2020 and U.S. Provisional Patent Application Ser. No. 62/991,862 filed on Mar. 19, 2020, each of which is hereby expressly incorporated by reference.

### BACKGROUND

### Technical Field

The present disclosure relates generally to the field of image analysis and image processing. More particularly, the present disclosure relates to systems and methods for disentangling factors of variation in computer vision systems using cycle-consistent variational auto-encoders.

### Related Art

Natural images can be thought of as samples from an unknown distribution with different factors of variation. The appearance of objects in images is influenced by factors of variation that may correspond to shape, geometric attributes, illumination, texture and pose. Depending on a task that is being performed (e.g., image classification), many of these factors serve as a distraction for computer vision systems (including prediction models), and are often referred to as nuisance variables. These nuisance variables are sometimes referred to as uninformative factors of variation.

One solution for mitigating the confusion caused by uninformative factors of variation is to design representations that ignore all nuisance variables. This approach, however, is limited by the quantity and quality of training data available for the computer vision system.

Another solution for mitigating the confusion caused by uninformative factors of variation is to train a classifier of a computer vision system to learn representations, including uninformative factors of variation, by providing sufficient diversity via data augmentation. Generative models that are driven by a “disentangled” (separated) latent space can be an efficient way of controlled data augmentation. Although Generative Adversarial Networks (hereinafter “GANs”) have proven to be excellent at generating new data samples, standard GAN architecture does not support inference over latent variables. This prevents control over different factors of variation during data generation. DNA-GANs introduce a fully supervised architecture to disentangle factors of variation, however, acquiring labels for each factor, even when possible, is cumbersome and time consuming.

Some solutions combine auto-encoders with adversarial training to “disentangle” or separate informative and uninformative factors of variation and map them to separate sets of latent variables. The informative factors, typically specified by the task of interest, are associated with the available source of supervision (e.g. class identity or pose), and are referred to as the specified factors of variation. The remaining uninformative factors are grouped together as unspecified factors of variation. Computer vision using such a model has two benefits. First, the encoder learns to factor out nuisance variables (e.g., unspecified factors of variation) for the task that is being performed. Second, the decoder can be used as a generative model that can generate new samples of images with controlled specified factors of variation and randomized unspecified factors of variation.

FIGS. 1(a)-(e) illustrate image grids generated by the system of the present invention as will be discussed in greater detail below, as well as prior art models for disentangling factors of variation where the model takes specified factors of variation(s) from the top row and unspecified factors of variation (z) from the first column. Digits within each grid are generated by solutions as will be discussed in greater detail below. FIG. 1(f) is a drawing of a degenerate solution for disentangled latent representations, which can be viewed as a failure case where the specified latent variables are entirely ignored by the decoder and all information (including image identity) is taken from the unspecified latent variables during image generation. FIGS. 1(c) and (d) are image grids showing the results of the failure case, in contrast to FIGS. 1(a) and (b) which show the result of the systems and methods of the present disclosure as will be discussed below. The degenerate situation is expected in auto-encoders unless the latent space is somehow constrained to preserve information about the specified and unspecified factors in the corresponding subspaces. Some solutions attempt to circumvent this issue by using an adversarial loss that trains an auto-encoder to produce images having an identity that is defined by the specified latent variables instead of the unspecified latent variables. While this strategy can produce good quality novel images, a drawback is that these solutions could train the decoder to ignore any leakage of information across the specified and unspecified latent spaces, rather than training the encoder to restrict any leakage of information.

Other solutions utilize the EM framework to discover independent factors of variation which describe the observed data. Other solutions learn bilinear maps from style and content parameters to images. Moreover, some solutions use Restricted Boltzmann Machines to separately map factors of variation in images. Further, some solutions model vision as an inverse graphics problem by using a network that disentangles transformation and lighting variations. Still further, some other solutions utilize identity and pose labels to disentangle facial identity from pose by using a modified GAN architecture. SD-GANs introduce a siamese network architecture over DC-GANs and BE-GANs, which simultaneously generates pairs of images with a common identity but different unspecified factors of variation. However, like standard GANs they lack any method for inference over the latent variables. Yet another solution can develop an architecture for visual analogy making, which transforms a query image according to the relationship between the images of an example pair. DNA-GANs present a fully supervised approach to learn disentangled representations. Adversarial auto-encoders use a semi-supervised approach to disentangle style and class representations, however, this approach cannot generalize to unseen object identities. Moreover, another approach can combine auto-encoders with adversarial training to disentangle factors of variation in a fully unsupervised manner.

Some solutions have also explored a non-adversarial approach to disentangle factors of variation. These solutions demonstrate that severely restricting the dimensionality of the unspecified latent space discourages the encoder from encoding information related to the specified factors of variation in it. However, this solution is extremely sensitive to the dimensionality of the unspecified space. As shown in FIG. 1E, even slightly plausible results require careful selection of dimensionality, which may not be possible in many circumstances.

Therefore, in view of existing technology in this field, what would be desirable are systems and methods for disentangling factors of variation in computer vision systems using cycle-consistent variational auto-encoders, which address the foregoing needs.

### SUMMARY

The present disclosure relates to systems and methods for disentangling factors of variation in computer vision systems using cycle-consistent variational auto-encoders. By sampling from the disentangled latent sub-space of interest, the systems and methods can efficiently generate new data necessary for a particular task. The systems and methods disentangle the latent space into two complementary subspaces by using only weak supervision in the form of pairwise similarity labels. The systems and methods use cycle-consistency in a variational auto-encoder framework to accomplish the objectives discussed herein. A non-adversarial approach used in the systems and methods of the present disclosure provides significant advantage over other prior art solutions.

### BRIEF DESCRIPTION OF THE DRAWINGS

The foregoing features of the invention will be apparent from the following Detailed Description, taken in connection with the accompanying drawings, in which:

FIGS. 1(a)-(b) are images of grids generated by the systems and methods of the present disclosure for disentangling factors of variation;

FIGS. 1(c)-(e) are images of grids generated by prior art systems for disentangling factors of variation;

FIG. 1(f) is a diagram of a degenerate solution for disentangled latent representations;

FIG. 2(a) is a diagram illustrating a forward cycle in a cycle-consistent framework;

FIG. 2(b) is a diagram illustrating a backward cycle in a cycle-consistent framework;

FIG. 3 if a flowchart illustrating processing steps carried out by the system of the present disclosure for generating disentangled representations of specified and unspecified latent variables from an image dataset;

FIG. 4 is a diagram illustrating a forward cycle design of the systems and methods of the present disclosure;

FIG. 5 is a flowchart illustrating processing steps carried out by the system for a forward cycle process for generating a reconstructed images;

FIG. 6 is a diagram illustrating a reverse cycle design of the systems and methods of the present disclosure;

FIG. 7 is a flowchart illustrating processing steps carried out by the system for a reverse cycle design process for generating reconstructed images;

FIG. 8 is a table illustrating qualitative results generated by the systems and methods of the present disclosure;

FIGS. 9(a)-(c) are drawings which show t-SNE plots of the unspecified latent space obtained by different models;

FIGS. 10(a)-(f) are image grids generated by combining specified factors of variation in one image and unspecified factors of variation in another image;

FIGS. 11(a)-(f) show image generation results on 2D Sprites by swapping z and s variables;

FIGS. 12(a)-(f) show image generation results on LineMod by swapping z and s variables;

FIGS. 13(a)-(c) are drawings showing the result of linear interpolation of the latent manifolds learned by a model of the systems and methods of the present disclosure;

FIGS. 14(a)-(c) shows the result of conditional image generation by sampling directly from a prior p(z); and

FIG. 15 is a diagram illustrating hardware and software components of a computer system on which the system of the present disclosure could be implemented.

### DETAILED DESCRIPTION

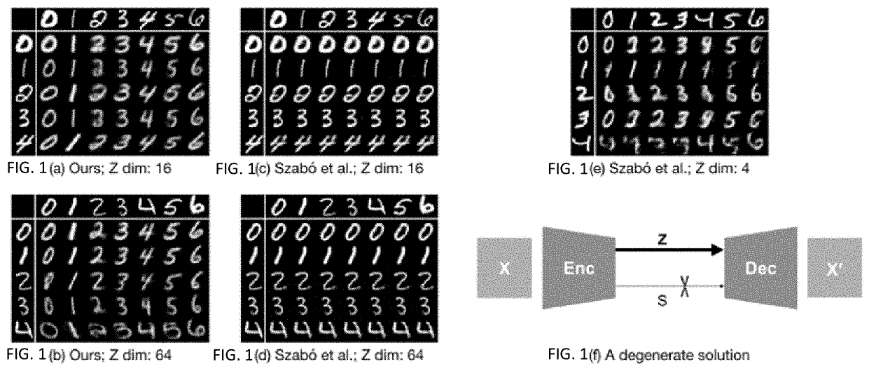

The present disclosure relates to systems and methods for disentangling factors of variation with cycle-consistent variational auto-encoders, as discussed in detail below in connection with FIGS. 1-15.

As will be apparent below, the systems and methods of the present disclosure use variational auto-encoders. A variational inference approach for an auto-encoder based latent factor model can be used. The system can define a dataset as X={xᵢ}ᵢ₌₁^{N} which can contain N i.i.d samples. Each sample can be associated with a continuous latent variable zᵢ drawn from some prior p(z) usually having a simple parametric form. The approximate posterior q_{ϕ}(z|x) can be parameterized using the encoder, while the likelihood term p_{θ}(x|z) can be parameterized by the decoder. The architecture, popularly known as Variational Auto-Encoders (VAEs), optimizes the following variational lower-bound equation:

[symbol]

(θ,ϕ;x)= [symbol] _{q}_{_{ϕ}}_{(z|x)}[log p_{θ}(x|z)]−KL(q_{ϕ}(z|x)∥p(z))

The first term in the equation is the expected value of the data likelihood, while the second term, the KL divergence, acts as a regularizer for the encoder to align the approximate posterior with the prior distribution of the latent variables. By employing a linear transformation based reparameterization, an end-to-end training of the VAE using back-propagation is enabled. At test time, VAEs can be used as a generative model by sampling from the prior p(z) followed by a forward pass through the decoder. The present systems and methods use the VAE framework to model the unspecified latent subspace.

The systems and methods of the present disclosure also use generative adversarial networks (“GANs”). GANs can model complex, high dimensional data distributions and generate novel samples from it. GANs include two artificial neural networks, a generator and a discriminator, both of which can be trained together in a min-max game setting, by optimizing the loss in below equation:

$${min}_{G} {max}_{D} V ( D , G ) = {x \sim pdata ( x )}_{} [ log D ( x ) ] + {z \sim pz ( z )}_{} [ log ( 1 - D ( G ( z ) ) ) ] \qquad ( 2 )$$

The discriminator outputs the probability that a given sample represents a true data distribution as opposed to being a sample from the generator. The generator can correlate random samples from a simple parametric prior distribution in the latent space with samples from the true distribution. The generator can be successfully trained when the output of the discriminator is ½ for all generated samples. DCGANs use CNNs to replicate complex image distributions and can be used for successful adversarial training. Non-adversarial training can be used in the systems and methods of the present disclosure.

Cycle-consistency methods are also used herein. Cycle-consistency has been used to enable a Neural Machine Translation system to learn from unlabeled data by following a closed loop of machine translation. Cycle-consistency can be used to establish cross-instance correspondences between pairs of images depicting objects of the same category. Cycle-consistent architectures can also be used with in depth estimation, unpaired image-to-image translation and unsupervised domain adaptation. The present systems and methods also leverage cycle-consistency in the unspecified latent space and explicitly train the encoder to reduce leakage of information associated with specified factors of variation.

The systems and methods of the present disclosure can combine auto-encoders with non-adversarial training to disentangle specified and unspecified factors of variation based on a single source of supervision, like class labels. In particular, the present disclosure introduces a non-adversarial approach to disentangle factors of variation under a weak source of supervision which uses only pairwise similarity labels.

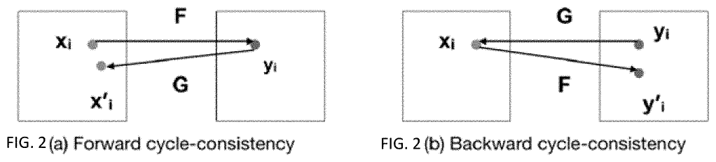

FIG. 2(a) is a diagram illustrating a forward cycle in a cycle-consistent framework and FIG. 2(b) is diagram illustrating a backward cycle in a cycle-consistent framework. A cycle-consistent framework is simple and efficient which improves the processing of images. Moreover, the forward and reverse transformations composited together in any order will approximate an identity function. For the forward cycle, this translates to a forward transform F(xᵢ) followed by a reverse transform G(F(xᵢ))=xᵢ′, such that xᵢ′≃xᵢ. The reverse cycle will ensure that a reverse transform followed by a forward transform yields F(G(yᵢ))=→yᵢ′≃yᵢ. The mappings F(·) and G(·) can be implemented using neural networks with training done by minimizing the [symbol] ₚ norm based cyclic loss defined in below equation:

L_{cyclic}=L^{forward}+Lᵣₑᵥₑᵣₛₑ

[symbol]

_{cyclic}= [symbol] _{x˜p(x)}[∥G(F(x))−x∥ₚ]+ [symbol] _{y˜p(y)}[∥F(G(y))−y∥ₚ] (3)

Cycle-consistency naturally fits into the variational auto-encoder training framework, where the KL divergence regularized reconstruction includes the [symbol] _{forward}. The systems and methods also use the reverse cycle-consistency loss to train the encoder to disentangle better. As is typical for such loss functions, the model is trained by alternating between the forward and reverse losses.

The systems and methods of the present disclosure use a conditional variational auto-encoder based model, where the latent space is partitioned into two complementary subspaces. The first subspace is “s,” which controls specified factors of variation associated with the available supervision in the dataset. The second subspace is “z,” which models the remaining unspecified factors of variation. The systems and methods keep s as a real value vector space and z is assumed to have a standard normal prior distribution p(z)= [symbol] (0,1). Such an architecture enables explicit control in the specified subspace, while permitting random sampling from the unspecified subspace. It can be assumed that there is a marginal independence between z, and s, which implies complete disentanglement between the factors of variation associated with the two latent subspaces.

The encoder can be written in the following equation: Enc(x)=(ƒ_{z}(x), ƒₛ(x), ƒₛ(x)), where ƒ_{z}(x)=(μ,σ)=z and ƒₛ(x)=s. Function ƒₛ(x) is a standard encoder with a real value vector latent space. Moreover, ƒ_{z}(x) is an encoder whose vector outputs parameterize the approximate posterior q_{ϕ}(z|x). Since the same set of features extracted from x can be used to create mappings to z and s, the systems and methods can define a single encoder with shared weights for all but the last layer, which branches out to generate outputs of the two functions ƒ_{z}(x) and ƒₛ (x).

The decoder, x′=Dec(z,s), in this VAE is represented by the conditional likelihood p_{θ}(x|z,s). Maximizing the expectation of this likelihood w.r.t the approximate posterior and s is equivalent to minimizing the squared reconstruction error.

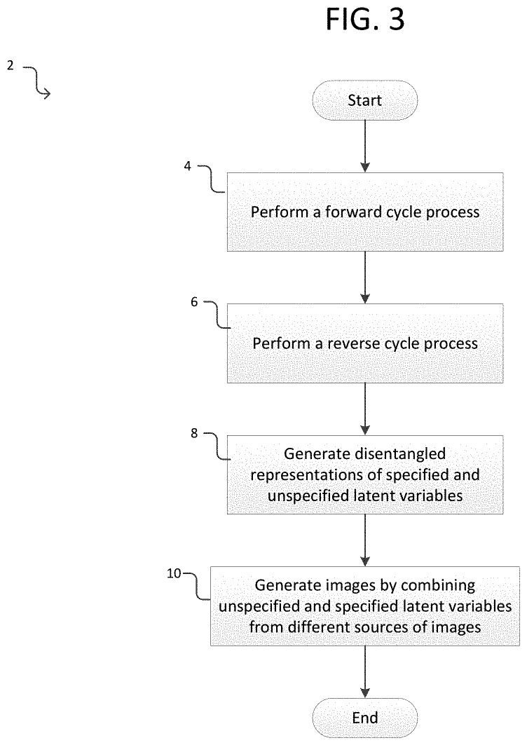

FIG. 3 if a flowchart illustrating processing steps 2 carried out by the systems and methods of the present disclosure for generating disentangled representations of specified and unspecified latent variables from an image dataset. In step 4, a forward cycle process is performed. In step 6, a reverse cycle process is performed. In step 8, the process 2 generates disentangled representations of specified and unspecified latent variables. Optionally, in step 10, the process 2 generates images by combining unspecified and specified latent variables from different sources of images.

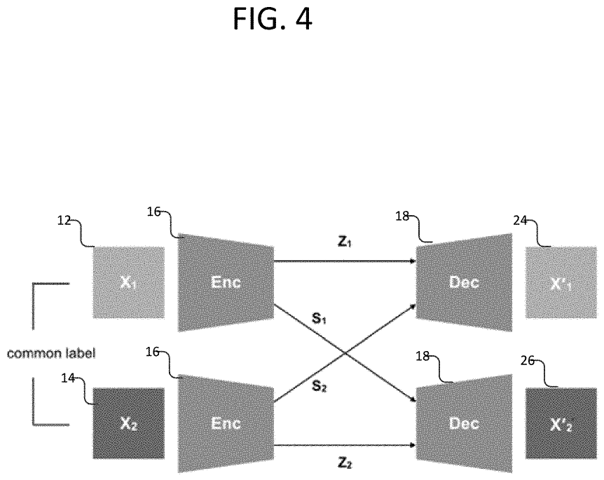

FIG. 4 is a diagram illustrating a forward cycle of the systems and methods of the present disclosure. The systems and methods of the present disclosure can sample a first image x₁ 12 and a second image x₂ 14 from the dataset that have the same class label. The first image x₁ 12 and the second image x₂ 14 can be passed through an encoder 16. This can generate corresponding latent representations, Enc(x₁)=(z₁,s₁) and Enc(x₂)=(z₂,s₂). The input to a decoder 18 is given by swapping the specified latent variables of the two images, as shown in FIG. 4. This process works with pairwise similarity labels, as the systems and methods do not need to know the actual class label of the sampled image pair. This produces the following reconstructions: x₁′=Dec(z₁,s₂) and x₂′=Dec(z₂,s₁). Since a first reconstructed image 24 and a second reconstructed image 26 share class labels, swapping the specified latent variables has no effect on the reconstruction loss function. Accordingly, the conditional likelihood of the decoder can be written as p_{θ}(x|z,s*), where s*=ƒₛ (x*) and x* is any image with the same class label as x. The entire forward cycle minimizes the modified variational upper-bound given in the below equation.

$${min}_{Enc , Dec} {forward}_{} = - {q φ ( x \vert z , {s}^{*} )}_{} [ log {p}_{θ} ( x \vert z , {s}^{*} ) ] + KL ( {q}_{φ} ( z \vert x , {z}^{*} ) ‖ p ( z ) ) \qquad ( 4 )$$

It is worth noting that forward cycle does not demand actual class labels at any given time. This can result in a weaker form of supervision. Accordingly, it may be desirable to use images which are annotated with pairwise similarity labels. The forward cycle mentioned above is similar to an auto-encoder reconstruction loss system or method.

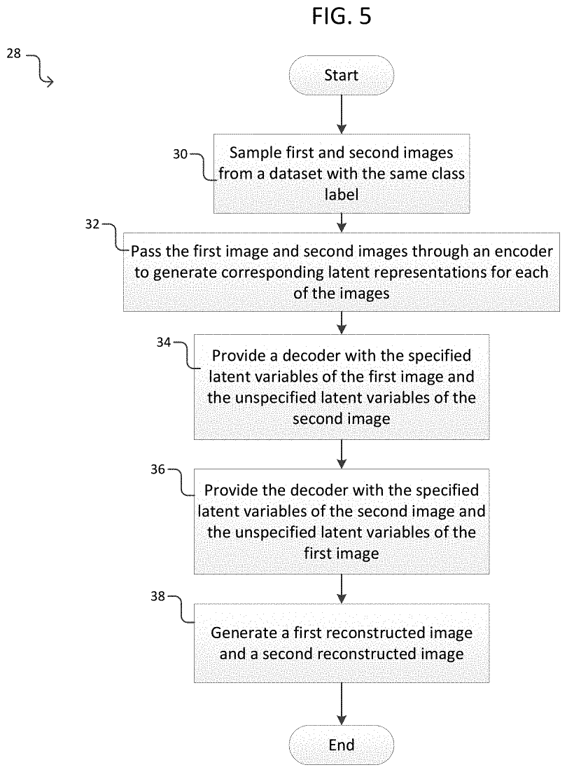

FIG. 5 is a flowchart illustrating processing steps 28 carried out by the systems and methods of the present disclosure for a forward cycle process for generating a reconstructed images. In step 30, a first and second image are sampled from a dataset with the same class label. In step 32, the first and second images are passed through to an encoder to generate corresponding latent representations for each of the images. In step 34, a decoder is provided with specified latent variables of the first image and unspecified latent variables of the second image. In step 36, the decoder is provided with specified latent variables of the second image with unspecified latent variables of the first image. In step 38, a first reconstructed image and a second reconstructed image are generated.

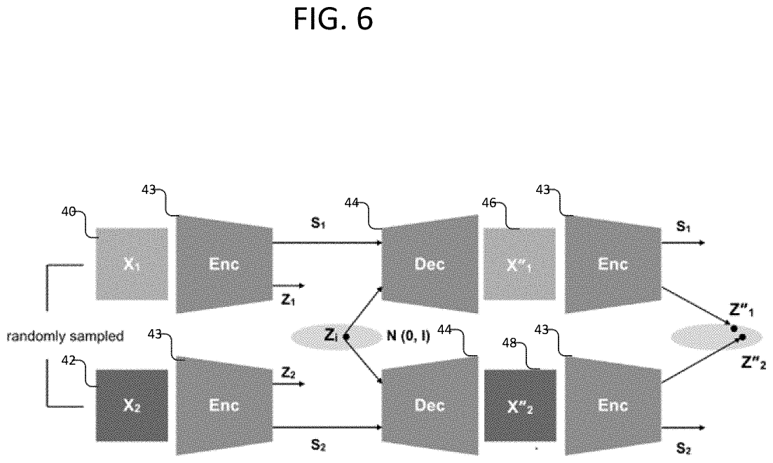

FIG. 6 is a diagram illustrating a reverse cycle of the systems and methods of the present disclosure. The reverse cycle is based on the idea of cyclic-consistency in the unspecified latent space. As can be seen in FIG. 6, a first image 40 and a second image 42 are randomly sampled. The first image 40 and the second image 42 are passed through to an encoder 43. The present systems and methods sample a point zᵢ from the Gaussian prior p(z)= [symbol] (0,1) over the unspecified latent space. Specified latent variables s₁=ƒₛ(x₁) and s₂=ƒₛ(x₂) are also sampled. The specified latent variables and the sampled unspecified variables are passed through a decoder 44 to obtain reconstructions x₁″=Dec(z₁,s₁) and x₂″=dec(z₁,s₂); respectively. Unlike the forward cycle, x₁ and x₂ need not have the same label and can be sampled independently. A third image x₁″ 46 and a fourth image x₂″ 48 can be pass through the encoder 43. Since both images x₁″ 46 and x₂″ 48 are generated using the same z₁, their corresponding unspecified latent embeddings z₁″=ƒ_{z}(x₁″) and z₂″(x₂″) should be mapped close to each other, regardless of their specified factors. Such a constraint promotes marginal independence of z from s as images generated using different specified factors could potentially be mapped to the same point in the unspecified latent subspace. This step directly drives the encoder to produce disentangled representations by only retaining information related to the unspecified factors in the z latent space. As FIG. 6 shows, a point sampled from the z latent space, combined with specified factors from two separate sources, forms two different images. However, the same sampled point can be obtained in the z space if the two generated images are passed back through the encoder.

The variational loss in the below equation enables sampling of the unspecified latent variables and aids the generation of novel images.

$${{min}_{Enc} {reverse}_{} = - {{x}_{1} , {z}_{1} \sim p ( x ) , {z}_{1} \sim 𝒩 ( 0 , 1 )}_{} [ ‖ fzDec ( {z}_{i} , {f}_{s} ( {x}_{1} ) ) ) - fzDec ( {z}_{i} , {f}_{s} ( {x}_{2} ) ) ) ‖}_{1} ]$$

In some cases, the encoder may not necessarily learn a unique mapping from the image space to the unspecified latent space. In other words, samples with similar unspecified factors may get mapped to different unspecified latent variables. Accordingly, to address this observation the above pairwise reverse cycle loss equation can penalize the encoder if the unspecified latent embeddings z₁″ and z₂″ and have a large pairwise distance, but not if they are mapped farther away from the originally sampled point z₁. Minimizing the pairwise reverse cycle loss in the above equation can be more beneficial than its absolute counterpart (∥z₁−z₁″∥+∥z₁−z₂″∥), both in terms of the loss value and the extent of disentanglement.

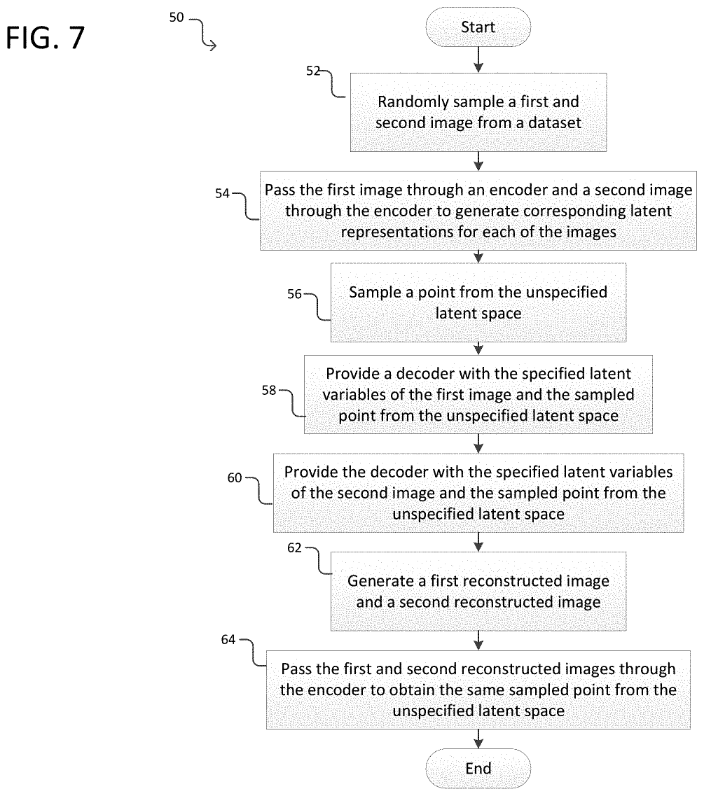

FIG. 7 is a flowchart illustrating processing steps 50 carried out by the systems and methods of the present disclosure for a reverse cycle design process for generating reconstructed images. In step 52, a first and second image are randomly sampled from a dataset. In step 54, the first and second images are passed through an encoder to generate corresponding latent representations for each of the images. In step 56, a point is sampled from the unspecified latent space. In step 58, a decoder is provided with the specified latent variables of the first image and the sampled point from the unspecified latent space. In step 60, a decoder is provided with the specified latent variables of the second image and the sampled point from the unspecified latent space. In step 62, first and second reconstructed images are generated. Optionally, in step 64, first and second reconstructed images can be passed through the encoder to obtain the same sampled point from the unspecified latent space.

Testing of the above systems and methods will now be explained in greater detail. The performance of the above systems and methods are evaluated on three datasets: MNIST, 2D Sprites and LineMod. The experiments are divided into two parts. The first part evaluates the performance of the systems and methods in terms of the quality of disentangled representations. The second part evaluates the image generation capabilities of the systems and methods.

The MNIST dataset includes of hand-written digits distributed among 10 classes. The specified factors in case of MNIST is the digit identity, while the unspecified factors control digit slant, stroke width etc.

2D Sprites dataset includes game characters (sprites) animated in different poses for use in small scale indie game development. The dataset includes 480 unique characters according to variation in gender, hair type, body type, armor type, arm type and greaves type. Each unique character is associated with 298 different poses, 120 of which have weapons and the remaining do not. In total, there are 143,040 images in the dataset. The training, validation and the test set contain 320, 80 and 80 unique characters respectively. This implies that character identity in each of the training, validation and test split is mutually exclusive and the dataset presents an opportunity to test the model on completely unseen object identities. The specified factors latent space for 2D Sprites is associated with the character identity, while the pose is associated with the unspecified factors.

LineMod is an object recognition and 3D pose estimation dataset with the following 15 unique objects photographed in a highly cluttered environment: ‘ape’, ‘benchviseblue’, ‘bowl’, ‘cam’, ‘can’, ‘cat’, ‘cup’, ‘driller’, ‘duck’, ‘eggbox’, ‘glue’, ‘holepuncher’, ‘iron’, ‘lamp’ and ‘phone.’ The synthetic version of the dataset is used, which has the same objects rendered under different viewpoints. There are 1,541 images per category and a split of a 1,000 images for training is used along with 241 images for validation and 300 images for testing. The specified factors in latent space can resemble the object identity in this dataset. The unspecified factors in latent space can resemble the remaining factors of variation in the dataset.

During the forward cycle, image pairs are randomly selected which are defined by the same specified factors of variation. During the reverse cycle, the selection of images is completely random. All of the models were implemented using the PyTorch programming language.

The quality of disentangled representations will now explained in greater detail. A two layer neural network classifier is trained separately on the specified and unspecified latent embeddings generated by each competing model. Since the specified factors of variation are associated with the available labels in each dataset, the classifier accuracy gives a fair measure of the information related to specified factors of variation present in the two latent subspaces. If the factors were completely disentangled, it would be expected that the classification accuracy in the specified latent space would be perfect, while that in the unspecified latent space would be close to chance. In this experiment, the effect of change in the dimensionality of the latent spaces is also investigated.

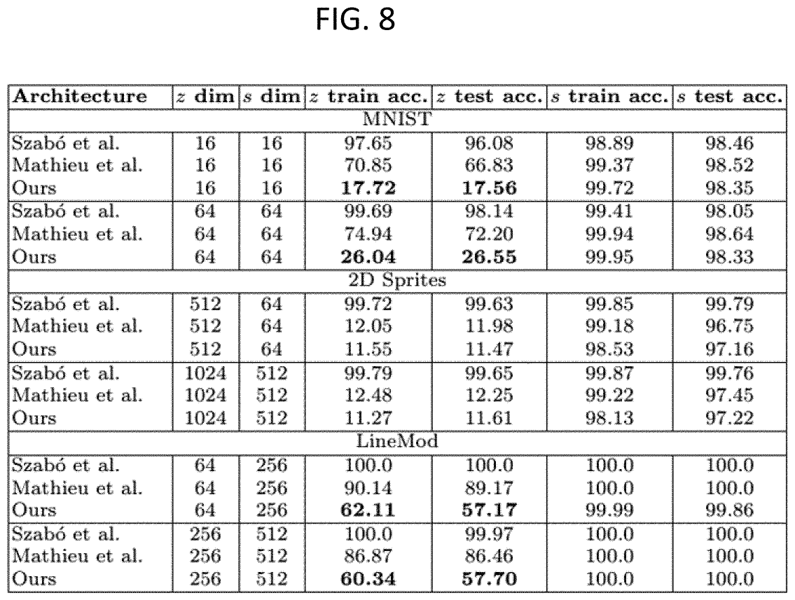

FIG. 8 is a table illustrating qualitative results of systems and methods of the present disclosure. Classification accuracies on the z and s latent spaces are a good indicator of the amount of specified factor information present in them. Since the goal is to aim for disentangled representations for unspecified and specified factors of variation, lower is better for the z latent space and higher is better the s latent space. The quantitative results in FIG. 8 show consistent trends for the present Cycle-Consistent VAE architecture across all the three datasets as well as for different dimensionality of the latent spaces.

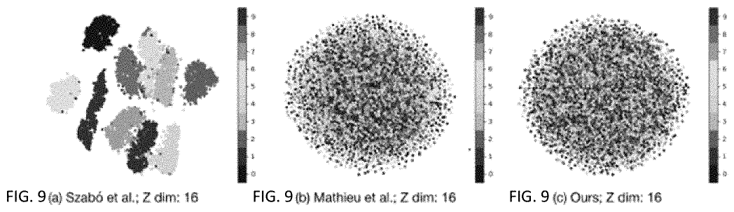

FIG. 9(a)-(c) are drawings which show t-SNE plots of the unspecified latent space obtained by different models. The unspecified latent space can be visualized as t-SNE plots to check for the presence of any apparent structure based on the available labels with the MNIST dataset. The points are labelled to indicate specified factor labels, which in the case of the MNIST dataset would be the digit identities. As can be seen, a clear cluster structures in FIG. 9(a) indicate strong presence of the specified factor information in the unspecified latent space. FIG. 9(a) also shows a good cluster formation according to class identities, indicating that adversarial training alone does not promote marginal independence of z from s. This observation is consistent with the quantitative results shown in FIG. 8. As shown in FIGS. 9(b) and (c), the t-SNE plots for another model and present model appear to have similar levels of confusion with respect to the specified factor information. The model shown in FIG. 9(b) uses re-parameterization on the encoder output to create confusion regarding the specified factors in the z space while retaining information related to the unspecified factors. The present systems and methods shown in FIG. 9(c) combines re-parameterization with reverse cycle loss to create confusion regarding the specified factors, which is the most efficient and accurate solution. However, since t-SNE plots are approximations, the quantitative results shown in FIG. 8 better capture the performance comparison. The present systems and methods benefit from the reparametrization. Significantly lower classification accuracies on the unspecified latent space embeddings indicate that the encoder learns to disentangle the factors better by minimizing the reverse cycle-consistency loss.

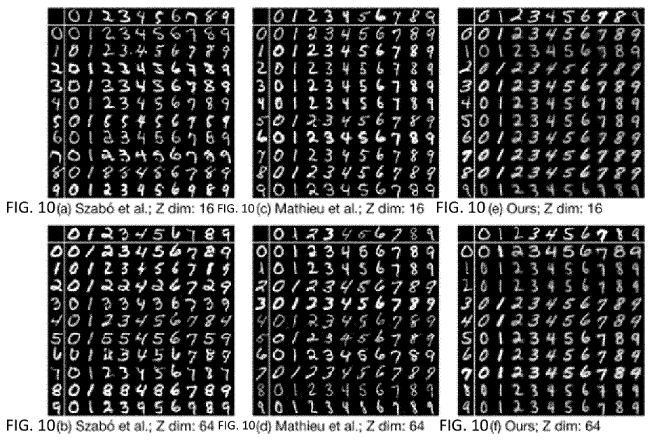

FIGS. 10(a)-(f) are image grids generated by combining specified factors of variation in one image and unspecified factors of variation in another image. In particular, the image grids are generated by swapping z and s variables. The top row and the first column are randomly selected from the test set. The remaining grid is generated by taking z from the digit in first column and s from the digit in first row. This keeps the unspecified factors constant in rows and the specified factors constant in columns. These figures illustrate the quality of image generation of the present systems and methods. The quality of image generation is evaluated in three different ways. First, the capability of the model was tested to combine unspecified and specified latent variables from different sources or images to generate a new image. This experiment is done in form of a grid of images, where the first row and the first column is taken from the test set. The remaining grid is generated with images by combining the specified factor of variation from images in the first row and the unspecified factors of variation from images in the first column. The present systems and methods perform well regardless of choices relating to dimensionality for both z and s variables. Accordingly, the present systems and methods avoids degeneracy for significantly higher dimensions of latent variables, in comparison to the base values, despite being a non-adversarial architecture. Second, the variation captured is shown in the two latent manifolds of the models by linear interpolation. The images in the top-left and the bottom-right corner are taken from the test set, and similar to the first evaluation, the remaining images are generated by keeping z constant across the rows and s constant across the columns. And lastly, the conditional image generation capability of the model is checked by conditioning on the s variable and sampling data points directly from the Gaussian prior p(z) for the z variable.

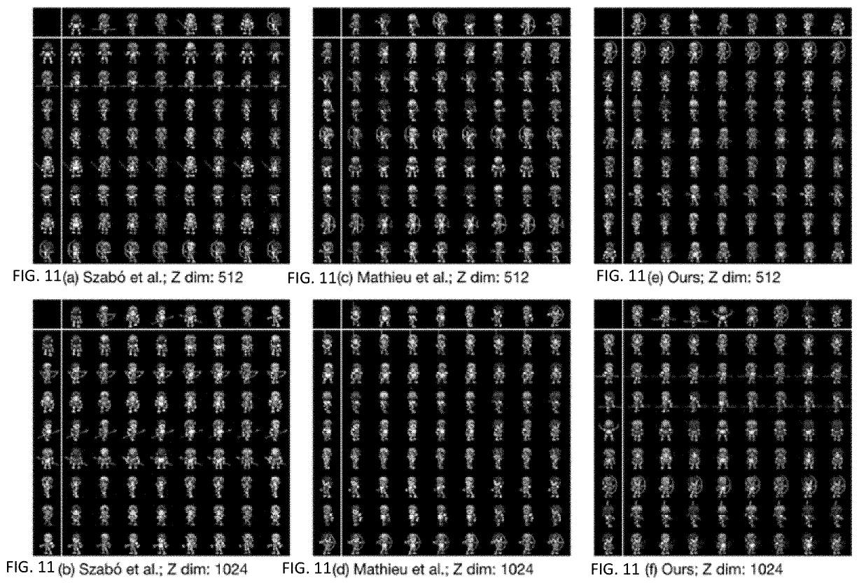

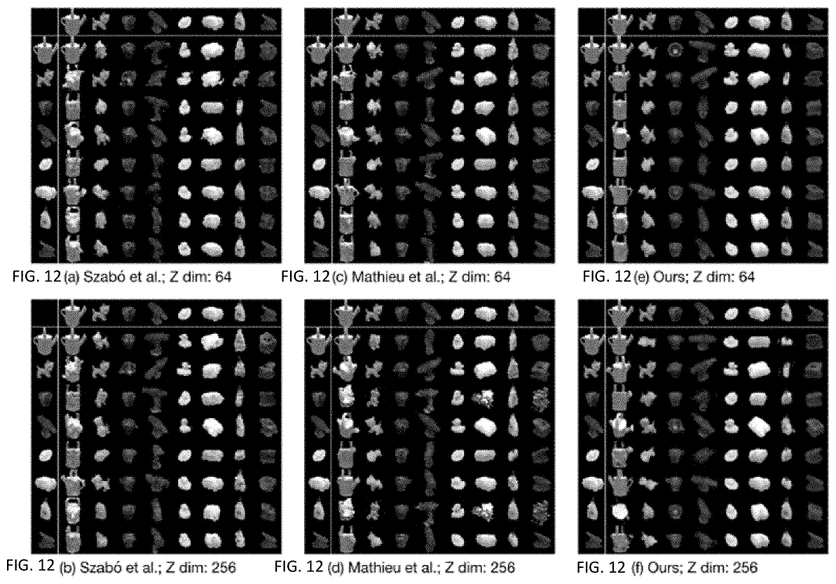

FIGS. 11(a)-(f) show image generation results on 2D Sprites by swapping z and s variables. FIGS. 12(a)-(f) show image generation results on LineMod by swapping z and s variables. LineMod dataset does not have a fixed alignment of objects for the same viewpoint. For example, an image of a ‘duck’ will not be aligned in the same direction as an image of a ‘cat’ for a common viewpoint. Also, an assumption that viewpoint is the only factor of variation associated with the unspecified space does not hold true for LineMod due to the complex geometric structure of each object. Accordingly, as is apparent from FIG. 12, an interpretation of transfer of unspecified factors as a viewpoint transfer does not necessarily hold true. For a direct comparison of the transfer of unspecified factors between different models, the test images are kept constant across the different image grids shown for LineMod.

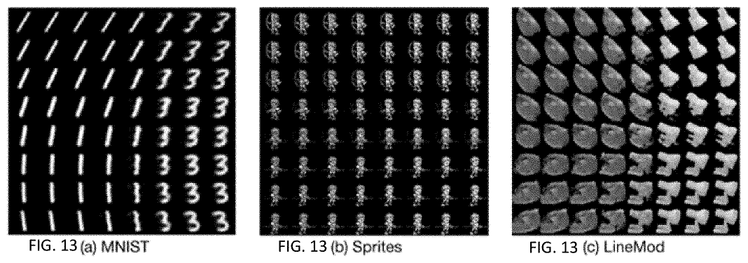

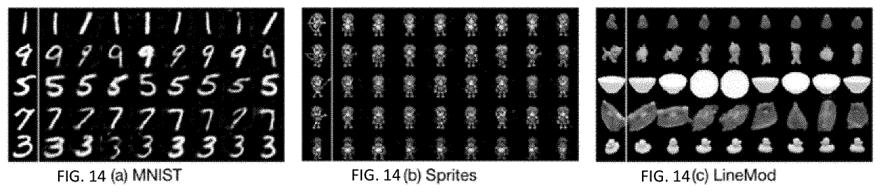

FIGS. 13(a)-(c) show the result of linear interpolation of the latent manifolds learned by the model for the three datasets. As can be seen, a direct transfer of viewpoint between the objects is not observed. Linear interpolation results are observed for the model in the z and s latent spaces. The images in the top-left and the bottom-right corner are taken from the test set. Like FIG. 10, the z variable is constant in the rows, while the s variable is constant in the columns. FIGS. 14a-14c shows the result of conditional image generation by sampling directly from the prior p(z), as well as image generation by conditioning on the s variable, taken from test images, and sampling the variable from [symbol] (0, 1).

As discussed in greater detail above, the systems and methods of the present disclosure provide a simple yet effective way to disentangle specified and unspecified factors of variation by leveraging the idea of cycle-consistency. The systems and methods include architecture that needs only weak supervision in the form of pairs of data having similar specified factors. The architecture does not produce degenerate results and is not impacted by the choices of dimensionality of the latent space. Through the experimental evaluations, it has been shown that the present systems and methods achieve compelling quantitative results on three different datasets and show good image generation capabilities as a generative model. It should also be noted that the cycle-consistent VAE could be trained as the first step, followed by training the decoder with a combination of adversarial and reverse cycle-consistency loss. This training strategy can improve the sharpness of the generated images while maintaining the disentangling capability of the encoder.

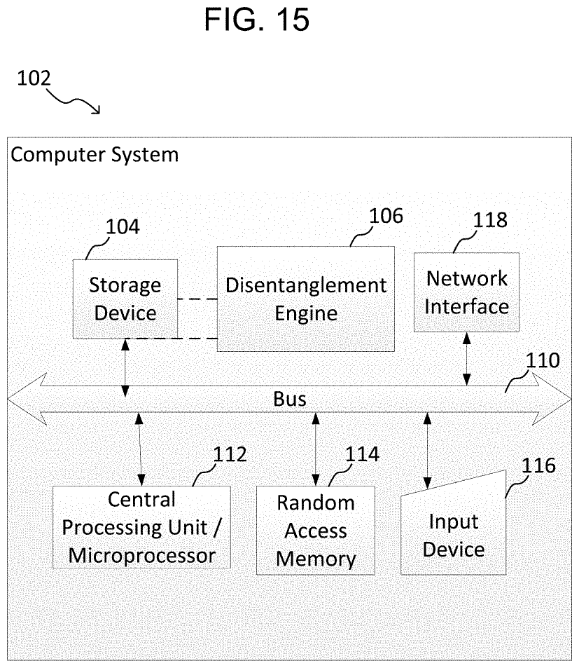

FIG. 15 is a diagram illustrating hardware and software components of a computer system on which the system of the present disclosure could be implemented. The system includes a processing server 102 which could include a storage device 104, a network interface 118, a communications bus 110, a central processing unit (CPU) (microprocessor) 112, a random access memory (RAM) 114, and one or more input devices 116, such as a keyboard, mouse, etc. The server 102 could also include a display (e.g., liquid crystal display (LCD), cathode ray tube (CRT), etc.). The storage device 104 could comprise any suitable, computer-readable storage medium such as disk, non-volatile memory (e.g., read-only memory (ROM), erasable programmable ROM (EPROM), electrically-erasable programmable ROM (EEPROM), flash memory, field-programmable gate array (FPGA), etc.). The server 102 could be a networked computer system, a personal computer, a smart phone, tablet computer etc. It is noted that the server 102 need not be a networked server, and indeed, could be a stand-alone computer system. The functionality provided by the present disclosure could be provided by disentangling factors of variation program/engine 106, which could be embodied as computer-readable program code stored on the storage device 104 and executed by the CPU 112 using any suitable, high or low level computing language, such as Python, Java, C, C++, C #, .NET, MATLAB, etc. The network interface 108 could include an Ethernet network interface device, a wireless network interface device, or any other suitable device which permits the server 102 to communicate via the network. The CPU 112 could include any suitable single- or multiple-core microprocessor of any suitable architecture that is capable of implementing and running the disentangling factors of variation program 106 (e.g., Intel processor). The random access memory 114 could include any suitable, high-speed, random access memory typical of most modern computers, such as dynamic RAM (DRAM), etc. The input device 116 could include a microphone for capturing audio/speech signals, for subsequent processing and recognition performed by the engine 106 in accordance with the present disclosure.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A computer vision system for image to image translation, comprising:
a memory; and
a processor in communication with the memory, the processor:
sampling a first image and a second image of a dataset, and
utilizing a variational auto-encoder model to execute a cycle consistent forward cycle and a cycle consistent reverse cycle on each of the first image and the second image to:
generate a disentanglement representation of the first image and a disentanglement representation of the second image, and
generate a first reconstructed image and a second reconstructed image based on the first image disentanglement representation and the second image disentanglement representation.

2. The system of claim 1, wherein the first image and the second image have a same class label and the processor utilizes the variational auto-encoder to execute the cycle consistent forward cycle on each of the first image and the second image by:
encoding, by a first image encoder, a specified latent variable of the first image into a first specified latent subspace and an unspecified latent variable of the first image into an unspecified latent space to generate the first image disentanglement representation,
encoding, by a second image encoder, a specified latent variable of the second image into a second specified latent subspace and an unspecified latent variable of the second image into the unspecified latent space to generate the second image disentanglement representation,
decoding, by a first image decoder, the first image encoded unspecified latent variable and the second image encoded specified latent variable to generate the first reconstructed image, and
decoding, by a second image decoder, the second image encoded unspecified latent variable and the first image encoded specified latent variable to generate the second reconstructed image.

3. The system of claim 1, wherein the first image and the second image are randomly sampled and the processor utilizes the variational auto-encoder to execute the cycle consistent reverse cycle on each of the first image and the second image by:
encoding, by a first image encoder, a specified latent variable of the first image into a first specified latent subspace and an unspecified latent variable of the first image into an unspecified latent space to generate the first image disentanglement representation,
encoding, by a second image encoder, a specified latent variable of the second image into a second specified latent subspace and an unspecified latent variable of the second image into the unspecified latent space to generate the second image disentanglement representation,
sampling a point from the unspecified latent space,
decoding, by a first image decoder, the sampled point from the unspecified latent space and the first image encoded specified latent variable to generate the first reconstructed image, and
decoding, by a second image decoder, the sampled point from the unspecified latent space and the second image encoded specified latent variable to generate the second reconstructed image.

4. The system of claim 3, wherein the processor utilizes the variational auto-encoder to retrieve the sampled point from the unspecified latent space by encoding the first reconstructed image and the second reconstructed image.

5. The system of claim 1 wherein the processor trains the variational auto-encoder with a cyclic loss function including a forward cycle loss function and a reverse cycle loss function.

6. The system of claim 5, wherein the forward cycle loss function is a Kullback-Leibler divergence regularized reconstruction loss function and the cycle consistent forward cycle minimizes an upper bound of the forward cycle loss function.

7. The system of claim 5, wherein the reverse cycle loss function is a pairwise loss function and the cycle consistent reverse cycle minimizes the reverse cycle loss function to train the variational auto-encoder to reduce leakage of a specified latent variable of the first image and a specified latent variable of the second image into an unspecified latent space of the first image and an unspecified latent space of the second image.

8. A method for image to image translation by a computer vision system, comprising the steps of:
sampling a first image and a second image of a dataset; and
utilizing a variational auto-encoder to execute a cycle consistent forward cycle and a cycle consistent reverse cycle on each of the first image and the second image to:
generate a disentanglement representation of the first image and a disentanglement representation of the second image, and
generate a first reconstructed image and a second reconstructed image based on the first image disentanglement representation and the second image disentanglement representation.

9. The method of claim 8, wherein the first image and the second image have a same class label and the step of utilizing the variational auto-encoder to execute the cycle consistent forward cycle on each of the first image and the second image comprises the steps of:
encoding, by a first image encoder, a specified latent variable of the first image into a first specified latent subspace and an unspecified latent variable of the first image into an unspecified latent space to generate the first image disentanglement representation,
encoding, by a second image encoder, a specified latent variable of the second image into a second specified latent subspace and an unspecified latent variable of the second image into the unspecified latent space to generate the second image disentanglement representation,
decoding, by a first image decoder, the first image encoded unspecified latent variable and the second image encoded specified latent variable to generate the first reconstructed image, and
decoding, by a second image decoder, the second image encoded unspecified latent variable and the first image encoded specified latent variable to generate the second reconstructed image.

10. The method of claim 8, wherein the first image and the second image are randomly sampled and the step of utilizing the variational auto-encoder to execute the cycle consistent reverse cycle on each of the first image and the second image comprises the steps of:
encoding, by a first image encoder, a specified latent variable of the first image into a first specified latent subspace and an unspecified latent variable of the first image into an unspecified latent space to generate the first image disentanglement representation,
encoding, by a second image encoder, a specified latent variable of the second image into a second specified latent subspace and an unspecified latent variable of the second image into the unspecified latent space to generate the second image disentanglement representation,
sampling a point from the unspecified latent space,
decoding, by a first image decoder, the sampled point from the unspecified latent space and the first image encoded specified latent variable to generate the first reconstructed image, and
decoding, by a second image decoder, the sampled point from the unspecified latent space and the second image encoded specified latent variable to generate the second reconstructed image.

11. The method of claim 10, further comprising the step of utilizing the variational auto-encoder to retrieve the sampled point from the unspecified latent space by encoding the first reconstructed image and the second reconstructed image.

12. The method of claim 8, further comprising the step of training the variational auto-encoder with a cyclic loss function including a forward cycle loss function and a reverse cycle loss function.

13. The method of claim 12, wherein the forward cycle loss function is a Kullback-Leibler divergence regularized reconstruction loss function and the cycle consistent forward cycle minimizes an upper bound of the forward cycle loss function.

14. The method of claim 12, wherein the reverse cycle loss function is a pairwise loss function and the cycle consistent reverse cycle minimizes the reverse cycle loss function to train the variational auto-encoder to reduce leakage of a specified latent variable of the first image and a specified latent variable of the second image into an unspecified latent space of the first image and an unspecified latent space of the second image.

15. A non-transitory computer readable medium having instructions stored thereon for image to image translation by a computer vision system, comprising the steps of:
sampling a first image and a second image of a dataset; and
utilizing a variational auto-encoder to execute a cycle consistent forward cycle and a cycle consistent reverse cycle on each of the first image and the second image to:
generate a disentanglement representation of the first image and a disentanglement representation of the second image, and
generate a first reconstructed image and a second reconstructed image based on the first image disentanglement representation and the second image disentanglement representation.

16. The non-transitory computer readable medium of claim 15, wherein the first image and the second image have a same class label and the step of utilizing the variational auto-encoder to execute the cycle consistent forward cycle on each of the first image and the second image comprises the steps of:
encoding, by a first image encoder, a specified latent variable of the first image into a first specified latent subspace and an unspecified latent variable of the first image into an unspecified latent space to generate the first image disentanglement representation,
encoding, by a second image encoder, a specified latent variable of the second image into a second specified latent subspace and an unspecified latent variable of the second image into the unspecified latent space to generate the second image disentanglement representation,
decoding, by a first image decoder, the first image encoded unspecified latent variable and the second image encoded specified latent variable to generate the first reconstructed image, and
decoding, by a second image decoder, the second image encoded unspecified latent variable and the first image encoded specified latent variable to generate the second reconstructed image.

17. The non-transitory computer readable medium of claim 15, wherein the first image and the second image are randomly sampled and the step of utilizing the variational auto-encoder to execute the cycle consistent reverse cycle on each of the first image and the second image comprises the steps of:
encoding, by a first image encoder, a specified latent variable of the first image into a first specified latent subspace and an unspecified latent variable of the first image into an unspecified latent space to generate the first image disentanglement representation,
encoding, by a second image encoder, a specified latent variable of the second image into a second specified latent subspace and an unspecified latent variable of the second image into the unspecified latent space to generate the second image disentanglement representation,
sampling a point from the unspecified latent space,
decoding, by a first image decoder, the sampled point from the unspecified latent space and the first image encoded specified latent variable to generate the first reconstructed image, and
decoding, by a second image decoder, the sampled point from the unspecified latent space and the second image encoded specified latent variable to generate the second reconstructed image.

18. The non-transitory computer readable medium of claim 15, further comprising the step of training the variational auto-encoder with a cyclic loss function including a forward cycle loss function and a reverse cycle loss function.

19. The non-transitory computer readable medium of claim 18, wherein the forward cycle loss function is a Kullback-Leibler divergence regularized reconstruction loss function and the cycle consistent forward cycle minimizes an upper bound of the forward cycle loss function.

20. The non-transitory computer readable medium of claim 18, wherein the reverse cycle loss function is a pairwise loss function and the cycle consistent reverse cycle minimizes the reverse cycle loss function to train the variational auto-encoder to reduce leakage of a specified latent variable of the first image and a specified latent variable of the second image into an unspecified latent space of the first image and an unspecified latent space of the second image.
